(19) United States
(12) Patent Application Publication
(10) Pub. No.: US 2011/0280032 A1
(43) Pub. Date: Nov. 17, 2011

(54) LIGHT-EMITTING DEVICE, ILLUMINATION DEVICE, AND VEHICLE HEADLIGHT

(75) Inventor: KATSUHIKO KISHIMOTO, OSAKA-SHI (JP)

(73) Assignee: SHARP KABUSHIKI KAISHA, OSAKA-SHI (JP)

(21) Appl. No.: 13/104,517

(22) Filed: May 10, 2011

(30) Foreign Application Priority Data
May 17, 2010 (JP) 2010-113474

(51) Int. Cl. B60Q 1/04; H01J 1/62; F21V 9/16

(52) U.S. Cl. 362/538; 362/84; 313/483

(57) ABSTRACT

To provide a light source which can emit light having a high luminance and a high luminous flux, a light-emitting device disclosed herein includes: a laser light source 101 for emitting a laser beam; and a light-emitting section 106 having an irradiation surface which the laser beam emitted by the laser light source 101 irradiates, the light-emitting section emitting light in response to the irradiation of the irradiation surface by the laser beam, the laser beam having, on the irradiation surface of the light-emitting section 106, a power density which falls within a range from 0.1 W/mm² to 100 W/mm².

This Nonprovisional application claims priority under 35 U.S.C. § 119(a) on Patent Application No. 2010-113474 filed in Japan on May 17, 2010, the entire contents of which are hereby incorporated by reference.

### TECHNICAL FIELD

The present invention relates to (i) a light-emitting device which functions as a light source having a high luminance and a high luminous flux, (ii) an illumination device including the light-emitting device, and (iii) a vehicle headlight including the light-emitting device.

### BACKGROUND ART

New light-emitting devices have been under rapid development for practical use to promote energy saving and disuse of environmentally hazardous substances. A light-emitting device which (i) combines a semiconductor light-emitting element and phosphors or (ii) includes an organic EL material is advantageous in that it is first of all higher in luminous efficiency than a conventional incandescent lamp. Such a light-emitting device is, for example, very high in luminous efficacy of source, which is a standard defined by JIS Z8113 in Japan. The luminous efficacy of source is expressed by a value obtained by dividing (i) a total luminous flux of light emitted by a light source by (ii) a power consumption of the light source. The above light-emitting device is also advantageous over a fluorescent lamp in various aspects. For example, the light-emitting device includes no environmentally hazardous substance such as mercury.

Development is particularly rapid for a white LED (light-emitting diode) which (i) includes, as a semiconductor light-emitting element, an LED emitting blue light and (ii) combines the LED with phosphors emitting yellow light. Such a white LED has been most actively developed for practical use in terms of, for example, brightness, efficiency, and cost. Some models of such a white LED are higher even in luminous efficiency than a fluorescent lamp.

There is, however, a negative side to the white LED. That is, it is difficult to improve its luminance (in cd/mm²). To simply improve brightness, a plurality of white LEDs can be used. It is, however, impossible to improve luminance by merely combining a plurality of light sources as above. This is because luminance is a luminous intensity per unit area.

This indicates that it is necessary to increase an input power for each LED so as to increase a luminous intensity per unit area and consequently to improve luminance. The white LED for current use is, however, designed to be supplied with an input power nearly to its limit, beyond which the white LED will generate a problematic amount of heat.

In view of the circumstances, a white LD (laser diode) has been under development (see, for example, Non Patent Literature 1). The white LD includes a semiconductor laser as a light source and causes the semiconductor laser to emit a laser beam to phosphors so that the phosphors emit light having a high luminance.

Luminance is normally a most important parameter of, for example, a light source to be mounted in an illumination device, such as a vehicle headlight (headlamp) and a projector, which needs to illuminate a distant place. This is because in a case where a high-luminance light source is used, it is possible to downsize an optical system included in a headlamp or a projector.

### Citation List

Non Patent Literature 1

Oyo Buturi, Vol. 74, No. 11, pp. 1463-1466 (2005)

### SUMMARY OF INVENTION

### Technical Problem

It has been difficult, however, to suitably use a conventional light-emitting device, such as a white LED and a white LD, as a light source in a headlamp or a projector as mentioned above. This is because there is a problem that such a conventional light-emitting device such as a white LED and a white LD cannot simultaneously achieve both a high luminance and a high luminous flux as described below.

There is already a commercially-available white LED which singly emits light having a luminous flux of greater than 100 lm (lumen). In a case where a plurality of such a white LED are integrated, it is possible to achieve an even greater luminous flux. However, there is great difficulty in further improving the luminance as described above. A white LD can achieve a high luminance, but can singly emit light having a luminous flux of only 100 lm at a maximum. This luminous flux is far lower than a luminous flux (approximately several hundreds to 3000 lm) which can be achieved by a halogen lamp or HID lamp in practical use in, for example, a headlamp.

In view of the above problem, it is an object of the present invention to provide (i) a light-emitting device which can function as a light source that can emit light having a high luminance and a high luminous flux, (ii) an illumination device including the light-emitting device, (iii) and a vehicle headlight including the light-emitting device.

### Solution to Problem

In order to solve the above problem, a light-emitting device of the present invention includes: a laser light source for emitting a laser beam; and a light-emitting section having an irradiation surface which the laser beam irradiates, the light-emitting section emitting light in response to the irradiation of the irradiation surface by the laser beam, the laser beam having, on the irradiation surface, a power density which falls within a range from 0.1 W/mm² to 100 W/mm².

In the above light-emitting device, the laser beam has, on the irradiation surface of the light-emitting section, a power density which falls within a range from 0.1 W/mm² to 100 W/mm². This arrangement (i) allows the light-emitting section to emit high-power light and yet (ii) prevents the light-emitting section from being degraded. As such, it is possible to provide a light-emitting device which can emit light having a high luminance and a high luminous flux.

The term “power density” as used herein refers to a quotient obtained by dividing (i) an output of the laser beam, emitted from the laser light source to irradiate the light-emitting section, by (ii) an area of the irradiation surface of the light-emitting section.

In a case where the light-emitting section has a luminous efficiency of only approximately 50%, the power density preferably falls within a range from 1.0 W/mm² to 100 W/mm².

For example, in the case where the light-emitting section has a luminous efficiency of approximately 50%, the light-emitting section has a light-emitting output of only 0.5 W even if the laser light source has an output of, for example, 1 W. If the light-emitting section has a light-emitting output of 0.5 W, the light-emitting section cannot emit light having a total luminous flux of 100 lm or greater. A total luminous flux of 100 lm is necessary for a light source to be suitably used in a headlamp or a projector. As such, in the above case, the laser beam has, on the irradiation surface of the light-emitting section, a power density which falls within the range from 1.0 W/mm² to 100 W/mm².

### ADVANTAGEOUS EFFECTS OF INVENTION

As described above, a light-emitting device of the present invention includes: a laser light source for emitting a laser beam; and a light-emitting section having an irradiation surface which the laser beam irradiates, the light-emitting section emitting light in response to the irradiation of the irradiation surface by the laser beam, the laser beam having, on the irradiation surface, a power density which falls within a range from 0.1 W/mm² to 100 W/mm².

As a result, it is possible to provide a light source which can emit light having a high luminance and a high luminous flux.

### BRIEF DESCRIPTION OF DRAWINGS

FIG. 1 is a side cross-sectional view schematically illustrating a configuration of a light-emitting device in accordance with a first embodiment of the present invention.

FIG. 2 is a cross-sectional view schematically illustrating a configuration of a GaN-based semiconductor laser serving as a laser light source in the light-emitting device in accordance with the first embodiment of the present invention.

FIG. 3 is a view schematically illustrating a configuration of a vehicle headlight including the light-emitting device in accordance with a second embodiment of the present invention.

FIG. 4 is a view schematically illustrating a configuration of a projector including the light-emitting device in accordance with a third embodiment of the present invention.

FIG. 5 is a view schematically illustrating an appearance of each of (i) a light-emitting unit included in a laser downlight of a fourth embodiment of the present invention and (ii) a conventional LED downlight.

FIG. 6 is a cross-sectional view illustrating a ceiling for which the laser downlight is installed.

FIG. 7 is a cross-sectional view illustrating the laser downlight.

FIG. 8 is a cross-sectional view illustrating an example variation of how the laser downlight is installed.

FIG. 9 is a cross-sectional view illustrating a ceiling for which the LED downlight is installed.

FIG. 10 is a table which compares specs of the laser downlight with those of the LED downlight.

### DESCRIPTION OF EMBODIMENTS

Embodiments of the present invention are described below with reference to the drawings. In the drawings referred to below, identical or similar members are assigned identical or similar reference numerals. For convenience of explanation, the drawings referred to below each illustrate, in a simplified manner, only main members among constituents involved in a corresponding embodiment of the present invention which main members need to be illustrated to describe the present invention. A light-emitting device and an illumination device of the present invention can thus include any constituent which is not illustrated in the drawings referred to in the present specification. Note that members illustrated in the drawings do not faithfully represent actual constituents in terms of aspects such as dimension and dimensional proportion.

### Embodiment 1

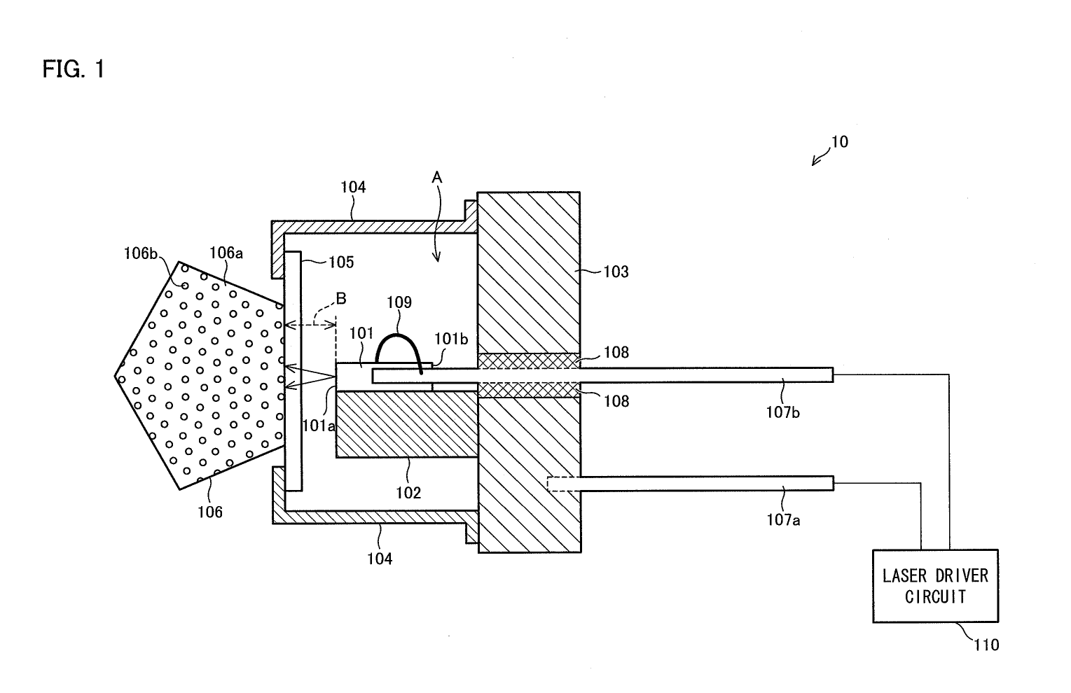

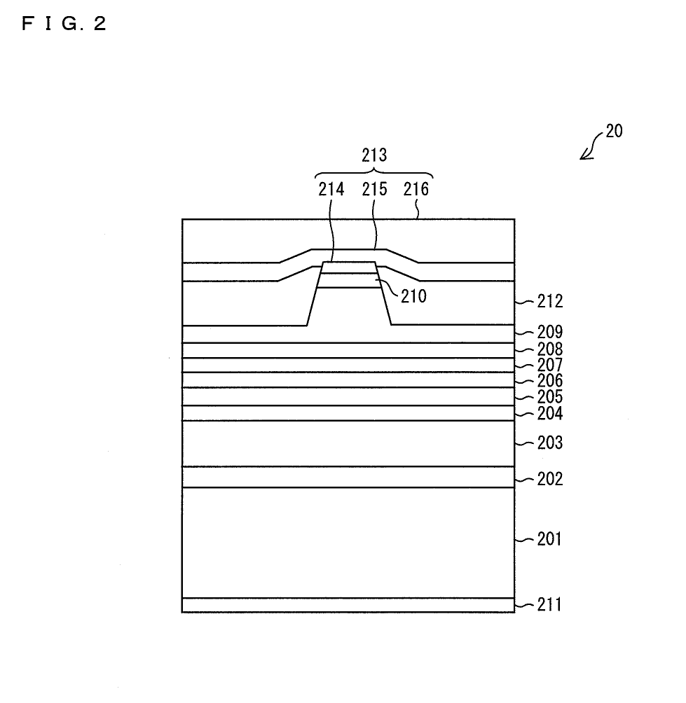

A first embodiment of the present invention is described below with reference to FIGS. 1 and 2.

### (Configuration of Light-Emitting Device 10)

FIG. 1 is a side cross-sectional view schematically illustrating a configuration of a light-emitting device 10 of a first embodiment of the present invention. As illustrated in FIG. 1, the light-emitting device 10 includes: a laser light source 101; a stem block 102; a stem 103; a cap 104; a cap glass section (transmitting section) 105; a light-emitting section 106; and electrode leads 107a and 107b.

The laser light source 101 has a front end surface 101a and a rear end surface 101b. The front end surface (emission end surface) 101a is a cleaved end surface for emitting a laser beam. The rear end surface 101b is a cleaved end surface located opposite to the front end surface 101a. The front and rear end surfaces 101a and 101b constitute a resonator for laser oscillation. The resonator has a resonance direction which coincides with a longitudinal direction of the stem block 102.

The laser light source 101 includes, for example, a semiconductor laser or a semiconductor laser-excited solid-state laser each having a single wavelength band or a plurality of wavelength bands. Specifically, the laser light source 101 includes, for example, a publicly known GaN (gallium nitride)-based semiconductor laser. The laser light source 101 emits laser light, which serves as an excitation light for exciting the light-emitting section 106.

In a case where the laser light source 101 includes a GaN-based semiconductor laser, the laser light source 101 can emit a laser beam having a wavelength of 405 nm (blue-violet light) and an output power of 10W. The description below deals with an example case in which the laser light source 101 includes a GaN-based semiconductor laser. A detailed structure of the GaN-based semiconductor laser will be described later.

The stem block 102 and the stem 103 are each made of an electrically conductive material such as copper. The above laser light source 101 is mounted on the stem block 102.

The stem block 102 is electrically connected to a lower electrode (not shown) provided on a main surface of the laser light source 101 which main surface faces the stem block 102. The stem block 102 is formed integrally with the stem 103. The lower electrode of the laser light source 101 is thus electrically connected to the electrode lead 107a via the stem block 102 and the stem 103.

Since the stem block 102 is formed integrally with the stem 103 as described above, heat generated by the laser light source 101 efficiently dissipates from the stem 103 via the stem block 102.

The stem 103 has an insertion hole (not shown), in which an end of the electrode lead 107a is inserted. The stem 103 is electrically connected to the electrode lead 107a.

The stem 103 also has a through hole, through which an end of the electrode lead 107b penetrates the stem 103. The stem 103 is electrically insulated from the electrode lead 107b. The stem 103 can be electrically insulated from the electrode lead 107b as above by inserting, for example, an insulating resin 108 between the stem 103 and the electrode lead 107b.

The cap 104 is provided on the stem 103 so as to encase the laser light source 101 and the stem block 102, on which the laser light source 101 is mounted. The cap 104 has a laser beam emission opening for allowing a laser beam emitted from the laser light source 101 to travel to the outside of the cap 104. The laser beam emission opening is provided so as to face the front end surface 101a of the laser light source 101.

The cap 104 in combination with the stem 103 and the cap glass section 105 forms a housing which is sealed so as to contain the laser light source 101 and the stem block 102. In other words, the laser light source 101 and the stem block 102 are provided in a space A inside a housing constituted by the stem 103, the cap 104, and the cap glass section 105 in a sealing manner.

The housing contains dry air in the space A. The dry air has a dew point temperature of −35° C.

The cap glass section 105 is provided so as to (i) face the front end surface 101a of the laser light source 101 and (ii) block the laser beam emission opening of the cap 104. The cap glass section 105 transmits a laser beam emitted from the front end surface 101a of the laser light source 101. The laser beam transmitted through the cap glass section 105 irradiates the light-emitting section 106.

The cap glass section 105 serves to transmit a laser beam emitted from the laser light source 101. The cap glass section 105 is thus made of a publicly known material, such as quartz, which transmits a laser beam.

The electrode lead 107a is a ground electrode electrically connected to the stem 103. The electrode lead 107a has a first end which is inserted in the stem 103 as described above. The electrode lead 107b is a semiconductor laser-driving electrode electrically connected to an upper electrode (not shown) provided on a main surface of the laser light source 101 which main surface is opposite to the stem block 102. The electrode lead 107b, as described above, has a first end which penetrates the stem 103 into the space A while being electrically insulated from the stem 103. The first end of the electrode lead 107b is electrically connected to the upper electrode via, for example, a Au wire 109.

The electrode leads 107a and 107b have their respective second ends which are both connected to, for example, a laser driver circuit 110. The laser driver circuit 110 continuously or intermittently applies a predetermined potential difference between the electrode leads 107a and 107b so as to supply a drive current between the upper and lower electrodes of the laser light source 101 to drive the laser light source 101.

The light-emitting section 106 is provided on the cap glass section 105 so as to face the front end surface 101a of the laser light source 101. The light-emitting section 106 has an irradiation surface at a bottom portion thereof, which irradiation surface is irradiated with a laser beam emitted from the laser light source 101.

The light-emitting section 106, which serves to emit light on irradiation of a laser beam on the irradiation surface, includes phosphors which emit light on receipt of a laser beam. Specifically, the light-emitting section 106 includes, for example, phosphors 106b dispersed in a phosphor supporting material (phosphor supporting member) 106a made of silicone resin. The phosphor supporting material 106a and the phosphors 106b are present in a ratio of approximately 10:1. The light-emitting section 106 can alternatively be made of the phosphors 106b which are pressed together. The phosphor supporting material 106a is not necessarily made of silicone resin, and can alternatively be made of glass.

The phosphors 106b are oxynitride phosphors or nitride phosphors, and emit light of different colors such as blue, green, and red. The phosphors 106b are dispersed in the phosphor supporting material 106a. In the case where the laser light source 101 includes a GaN-based semiconductor laser, the laser light source 101 emits a laser beam having a wavelength of 405 nm (blue-violet light). On irradiation of the laser beam, the light-emitting section 106 emits white light. The light-emitting section 106 thus serves as a wavelength converting material.

The above laser light source 101 can alternatively serve to emit a laser beam having a wavelength of 450 nm (blue light) or a laser beam having a wavelength close to the wavelength of blue light, that is, having a peak wavelength which falls within a range from 440 nm to 490 nm. In this case, the phosphors 106b include (i) yellow phosphors or (ii) a mixture of green phosphors and red phosphors. Yellow phosphors emit light having a peak wavelength which falls within a range from 560 nm to 590 nm. Green phosphors emit light having a peak wavelength which falls within a range from 510 nm to 560 nm. Red phosphors emit light having a peak wavelength which falls within a range from 600 nm to 680 nm.

The phosphors 106b are preferably oxynitride phosphors or nitride phosphors commonly referred to as “sialon phosphors.” Sialon is a substance in which the silicon atoms and nitrogen atoms in silicon nitride are partially substituted by aluminum atoms and oxygen atoms, respectively. Sialon phosphors can be prepared by making a solid solution of, for example, silicon nitride (Si₃N₄), alumina (Al₂O₃), silica (SiO₂), and a rare earth.

Another preferable example of the phosphors 106b is semiconductor nanoparticle phosphors made of nanometer-size III-V compound semiconductor particles. Semiconductor nanoparticle phosphors has a characteristic that even in a case where they are made of a single compound semiconductor (for example, indium phosphide [InP]), it is possible to change a color of emission light with use of a quantum size effect caused by changing a particle diameter of the semiconductor nanoparticle phosphors. For example, semiconductor nanoparticle phosphors made of InP emit red light in a case where it has a particle size (measured under a transmission electron microscope [TEM]) which falls within a range approximately from 3 nm to 4 nm.

Further, semiconductor nanoparticle phosphors, since they are semiconductor-based, have a short fluorescence lifetime, and quickly emit fluorescence in response to a power of excitation light. Semiconductor nanoparticle phosphors thus characteristically tolerate high-power excitation light well. Semiconductor nanoparticle phosphors have a light emission lifetime of approximately 10 nanoseconds, which is 10,000 times as short as a light emission lifetime of a normal phosphor material including a rare earth as a luminescent center. Since semiconductor nanoparticle phosphors have a short light emission lifetime, they can quickly repeat a cycle of excitation light absorption and fluorescence. Semiconductor nanoparticle phosphors consequently maintain a high fluorescence efficiency for intense excitation light, and thus generate only a reduced amount of heat. As such, it is possible to further prevent the light-emitting section 106 (light-converting member) from degradation (for example, color change and deformation) caused by heat. As a result, in a case where a light-emitting device includes as a light source a light-emitting element having a high light output, it is possible to prevent the light-emitting device from having a short lifetime.

The light-emitting section 106 can be prepared by, for example, (i) dispersing Caα-SiAlON:Ce phosphors and CASN:Eu phosphors in a ratio of 3:1 in silicone resin (X32-2712-A/B; available from Shin-Etsu Chemical Co., Ltd.) serving as an organic polymer member, (ii) thermally curing the dispersion, and (iii) molding the dispersion.

Caα-SiAlON:Ce phosphors are a kind of oxynitride phosphors, and are excited by light having a wavelength of 405 nm or its vicinity, and in response emit blue-green fluorescence. CASN:Eu phosphors are a kind of nitride phosphors, and are also excited by light having a wavelength of 405 nm or its vicinity, and in response emit red fluorescence. The light-emitting section 106, which includes the above two kinds of phosphors mixed and dispersed in the above ratio, is excited by a laser beam emitted from the laser light source 101 (GaN-based semiconductor laser) and in response emits white light.

The laser light source 101 emits from the front end surface 101a a laser beam, which is then transmitted through the cap glass section 105 and irradiates the irradiation surface located at a bottom portion of the light-emitting section 106.

In a case where the cap 104 was set to have a height of 2.5 mm from the stem 103, the laser beam emitted from the front end surface 101a of the laser light source 101 to the irradiation surface of the light-emitting section 106 had an output power density (in W/mm²) on the irradiation surface of the light-emitting section 106 which output power density fell within a range from 0.1 W/mm² to 10 W/mm².

During the above operation, the front end surface 101a of the laser light source 101 was separated from the irradiation surface of the light-emitting section 106 by a distance B of 1.0 mm. The laser beam had a power density of 5 W/mm² on the irradiation surface of the light-emitting section 106.

In a case where the laser driver circuit 110 supplied the laser light source 101 with an electric power of 35W, the laser light source 101 emitted a laser beam of 10W, in response to which the light-emitting section 106 emitted white light having a total luminous flux of 1800 lm and a luminance of 100 cd/mm². The white light had a general color rendering index Ra of 94 and a special color rendering index R9 of 95 for red.

The laser light source 101 is provided in the space A, in which the above-mentioned housing contains dry air. As such, the laser light source 101 can stably emit a high-power laser beam for an extended period of time. As described above, the present embodiment uses dry air having a dew point temperature of −35° C. With use of dry air having a dew point temperature of −30° C. or lower, the laser light source 101 can stably emit a high-power laser beam for an extended period of time even in the case where the laser light source 101 includes a GaN-based semiconductor laser.

The phosphors 106b dispersed in the phosphor supporting material 106a of the light-emitting section 106 are oxynitride phosphors. A base material for the oxynitride phosphors is SiAlON (or sialon), which is known as a superhard, extremely heat-resistant ceramic material. The oxynitride phosphors included in the light-emitting section 106 of the present embodiment are a phosphor material made of SiAlON. As such, the light-emitting section 106 is not degraded due to excitation by a laser beam having an extremely high power, specifically, having a power density on the irradiation surface of the light-emitting section 106 which power density falls within the range from 0.1 W/mm² to 10 W/mm². With this arrangement, the light-emitting device 10 can continue emitting light having a high thousands of hours, which largely exceeds a lifetime of a halogen lamp.

If the light-emitting section 106 is excited by a laser beam having a power density on the irradiation surface of the light-emitting section 106 which power density is less than 0.1 W/mm², the light-emitting device 10 cannot emit light having a high luminance of greater than 20 cd/mm².

This is because achieving a luminance equivalent to or higher than that of a halogen lamp (20 cd/mm²) requires a power density of 0.1 W/mm² or higher on the irradiation surface of the light-emitting section 106.

It is not impossible to cause a power density of the laser beam to be 0.1 W/mm² or higher on the irradiation surface of the light-emitting section 106 by, for example, converging the laser beam. However, if the laser beam itself has a low power (for example, 0.5 W or lower), the light-emitting section 106 cannot emit light having a total luminous flux of 100 lm or greater. The laser beam thus preferably has a power of 0.5 W or higher on the irradiation surface of the light-emitting section 106 so that the light-emitting section 106 can emit light having a high luminous flux.

If the light-emitting section 106 is excited for an extended period of time by a laser beam having a power density on the irradiation surface of the light-emitting section 106 which power density exceeds 10 W/mm², the phosphor supporting material 106a (organic polymer member) of the light-emitting section 106 may be decomposed and combusted. In view of the circumstances, the laser beam has a power density on the irradiation surface of the light-emitting section 106 which power density is 10 W/mm² or lower so that the phosphor supporting material 106a (organic polymer member) will not be decomposed and combusted.

The phosphor supporting material 106a can alternatively be made of an inorganic member such as glass in place of the above organic polymer member such as silicone resin. Inorganic members such as glass are higher in heat resistance than organic polymer members. In a case where the phosphor supporting material 106a is made of an inorganic member, the laser beam is simply required to have a power density on the irradiation surface of the light-emitting section 106 which power density is 100 W/mm² or lower so that the phosphor supporting material 106a (inorganic member) is prevented from, for example, degradation.

The present embodiment uses Caα-SiAlON:Ce phosphors and CASN:Eu phosphors as a material for the oxynitride phosphors. The light-emitting section 106 can highly reliably emit light in response to a high-power laser beam even with use of phosphors other than the above kinds, such as SCASN:Eu phosphors, β-SiAlON:Eu phosphors, and JEM phosphors. For example, JEM phosphors emitting blue light, β-SiAlON:Eu phosphors emitting green light, and CASN phosphors emitting red light can alternatively be used in combination so that light emission of the three primary colors (RGB) can be carried out with a high luminance and a high luminous flux. In this case, β-SiAlON:Eu phosphors can be replaced with Caα-SiAlON:Ce phosphors.

The organic polymer member, in which the above phosphors are dispersed, desirably has a chemical structure which contains a siloxane bond in its main chain and an organic group as a side chain. With this arrangement, the organic polymer member better tolerates a high-power laser beam.

In a case where the organic polymer member is, in particular, made of silicone resin having a methyl group (CH₃—) as a side chain, the organic polymer member does not unusually absorb light within a visible light wavelength range and is thus highly reliable. The present embodiment also uses silicone resin as the organic polymer member in which oxynitride phosphors or nitride phosphors are dispersed.

The present embodiment can be varied such that the cap glass section 105 is replaced with an organic polymer member in which oxynitride phosphors are dispersed. This variation prevents a laser beam (excitation light) from being lost as absorbed by the cap glass section 105. As such, it is possible to produce a light-emitting device having a high luminance and a high luminous flux which light-emitting device has an even higher luminous efficiency.

This variation should importantly use, as a material for the organic polymer member, a material which does not easily allow gas or water to pass through. This prevents dry air contained in the housing from escaping, and also prevents water from entering the housing from the outside.

The laser light source 101 of the present embodiment includes a GaN-based semiconductor laser having an oscillation wavelength of 405 nm. The laser light source 101 preferably includes, as an excitation light source for the light-emitting section 106, a GaN-based semiconductor laser having an oscillation wavelength which falls within a range from 400 nm to 420 nm.

A semiconductor laser light source emits light having a single, extremely sharp waveform. The laser light source 101 thus emits light having a wavelength of 400 nm or greater so that the light contains no UV-A component (having wavelength of up to 400 nm) which may cause a skin disorder. The light emitted by the laser light source 101 also has a wavelength of 420 nm or less so that a color rendering property of the light source is not adversely affected. Light within the wavelength range from 400 nm to 420 nm is extremely low in luminosity). Further, the above-described oxynitride phosphors and nitride phosphors each advantageously have a high absorptance for light within this wavelength range.

The GaN-based semiconductor laser can alternately have an oscillation wavelength which falls within a range from 440 nm to 470 nm.

In a case where the phosphors are excited by excitation light having a blue-color wavelength range which falls within the range from 440 nm to 470 nm, it is possible to reduce a Stokes loss (that is, an energy loss arising from a difference between an excitation wavelength and a fluorescence wavelength) as compared to excitation light having a wavelength which falls within the above range from 400 nm to 420 nm. With this arrangement, it is possible to cause the phosphors to emit light with a higher efficiency and consequently to produce a light-emitting device having a high luminous efficiency and emitting light having a high luminance and a high luminous flux.

### (Detailed Structure of GaN-Based Semiconductor Laser 20)

The following description deals with a detailed structure of a GaN-based semiconductor laser 20 used as the laser light source 101 illustrated in FIG. 1. FIG. 2 is a cross-sectional view schematically illustrating a configuration of the GaN-based semiconductor laser 20. Specifically, the cross-sectional view of FIG. 2 schematically illustrates a configuration of a ridge stripe section, included in the GaN-based semiconductor laser 20, as viewed from a front end surface 101a side of the laser light source 101 included in the light-emitting device 10 of FIG. 1. The GaN-based semiconductor laser 20 has an array structure including 10 of such a ridge stripe section.

The GaN-based semiconductor laser 20 includes nitride semiconductor layers each of which includes nitride semiconductor crystal represented by the following formula:

AlₓGa_{y}In_{z}N (where 0≦x≦1; 0≦y≦1; 0≦z≦1; and x+y+z=1)

In the above formula, “Al” is aluminum; “Ga” is gallium; “In” is indium; “N” is nitrogen; “x” is a content proportion for aluminum; “y” is a content proportion for gallium; and “z” is a content proportion for indium. In a case where the nitride semiconductor crystal included in each of the nitride semiconductor layers is a hexagonal crystal, 10% or lower of nitrogen in the nitride semiconductor layer can be substituted by at least one element selected from the group consisting of arsenic, phosphorus, and antimony.

In the description below, a nitride semiconductor layer including the nitride semiconductor crystal represented by the formula AlₓGa_{y}N (0<x<1, 0<y<1, and x+y=1) is referred to as “AlGaN layer.” The nitride semiconductor layer can also be doped with, for example, at least one selected from the group consisting of silicon, oxygen, chlorine, sulfur, selenium, carbon, germanium, zinc, cadmium, magnesium, and beryllium so as to have a conductivity type of either a p-type or an n-type. Among the above elements, magnesium is preferable as a p-type dopant. The following describes, with reference to the cross-sectional view of FIG. 2, an example configuration of the GaN-based semiconductor laser which includes nitride semiconductor layers each including the above nitride semiconductor crystal.

The GaN-based semiconductor laser 20 includes, on a front surface of an n-type GaN substrate 201, the following layers on top of one another in this order: an n-type GaN layer 202 having a thickness of 0.5 μm; an n-type Al_{0.05}Ga_{0.95}N lower clad layer 203 having a thickness of 2 μm; an n-type GaN guide layer 204 having a thickness of 0.1 μm; a GaN lower adjacent layer 205 having a thickness of 20 nm; an active layer 206 including (i) an undoped In_{0.15}Ga_{0.85}N well layer (thickness: 4 nm) and (ii) an undoped GaN barrier layer (thickness: 8 nm); a GaN upper adjacent layer 207 having a thickness of 50 nm; a p-type Al_{0.2}Ga_{0.8}N layer 208 having a thickness of 20 nm; a p-type Al_{0.1}Ga_{0.9}N upper clad layer 209 having a thickness of 0.6 μm; and a p-type GaN contact layer 210 having a thickness of 0.1 μm.

The GaN-based semiconductor laser 20 includes a p-side electrode 213 on the p-type GaN contact layer 210 and the insulating layer 212. The p-side electrode 213 corresponds to the upper electrode of the laser light source 101 illustrated in FIG. 1. The GaN-based semiconductor laser 20 further includes an n-side electrode 211 on a rear surface of the n-type GaN substrate 201. The n-side electrode 211 corresponds to the lower electrode of the laser light source 101 illustrated in FIG. 1.

In the GaN-based semiconductor laser 20 including the above layers stacked on one another as described above, the upper clad layer 209 and the contact layer 210 extend in a resonance direction in a stripe pattern so as to provide a ridge stripe type waveguide. The description below uses the term “ridge stripe” to refer to a portion of the GaN-based semiconductor laser 20 which portion includes the upper clad layer 209 and the contact layer 210 provided in a stripe pattern.

A region of the GaN-based semiconductor laser 20 which region does not correspond to the ridge stripe (that is, the upper clad layer 209 and the contact layer 210) is filled with an insulating layer 212 for current constriction. In the present embodiment, the ridge stripe including the upper clad layer 209 and the contact layer 210 has a width of approximately 7.0 μm, and the GaN-based semiconductor laser 20 has a resonator length of 600

The GaN-based semiconductor laser 20 including the ridge stripe has (i) a front end surface which is provided with an AR coating made of alumina and (ii) a rear end surface which is provided with an HR coating made of a laminate film including alternating alumina and titania layers. The p-type layers among the above layers stacked on one another as above each contain, as a p-type dopant, magnesium (Mg) in a concentration which falls within a range from 1×10¹⁹ cm⁻³ to 1×10²⁰ cm⁻³. The magnesium content is, for example, 4×10¹⁹ cm⁻³ in each of the upper clad layer 209 and the contact layer 210.

The active layer 206 has a multiple quantum well structure (including three wells) which includes, in an order presented below: (i) an undoped In_{0.15}Ga_{0.85}N well layer (thickness: 4 nm), (ii) an undoped GaN barrier layer (thickness: 8 nm), (iii) a layer identical to the above well layer, (iv) a layer identical to the above barrier layer, and (v) a layer identical to the above well layer. With the active layer 206 including the well and barrier layers composed as above, each barrier layer has a band gap energy larger than those of the well layers.

The p-side electrode 213 includes three layers, namely a first layer 214 (a Pd/Mo layer), a second layer 215 (a barrier layer), and a third layer 216 (pad). The three layers are stacked on one another in the above order with the first layer in contact with the p-type GaN contact layer 210. The second and third layers 215 and 216 are formed above the insulating layer 212 as well. The second layer 215 serving as a barrier layer preferably adheres well to the insulating layer 212. The first layer 214 includes a Pd layer serving to be in ohmic contact with a p-type nitride semiconductor. The first, second, and third layers 214, 215, and 216 included in the p-side electrode 213 are each deposited by a film deposition method such as electron beam (EB) vacuum deposition and high-frequency sputtering.

The GaN-based semiconductor laser 20 having the above configuration can be produced by a publicly known method for growing nitride semiconductor crystal. Specifically, the nitride semiconductor layers are each deposited by metal-organic chemical vapor deposition (MOCVD). The ridge stripe structure including the upper clad layer 209 and the contact layer 210 is formed by an etching treatment involving dry etching. In the case where MOCVD is used as mentioned above as a method for growing nitride semiconductor crystal so as to deposit nitride semiconductor layers, a carrier gas and a Group-V material gas will contain hydrogen. As such, the nitride semiconductor crystal will also contain hydrogen.

The method for growing nitride semiconductor crystal can alternatively be molecular beam epitaxy (MBE). In this case also, the nitride semiconductor crystal will contain hydrogen if, for example, ammonia is used as a Group-V material.

The GaN-based semiconductor laser 20 has an oscillation wavelength which falls within a range from 400 nm to 410 nm.

The GaN-based semiconductor laser 20 having the configuration of FIG. 2 serves merely as an example. The GaN-based semiconductor laser 20 of the present invention is not limited to the above-mentioned values in terms of aspects such as the thickness of each nitride semiconductor layer, the width of the ridge stripe, the number of ridge stripes, and the resonator length. The p-type GaN contact layer 210, for example, can be omitted so that the upper clad layer 209 serves also as a contact layer. The well and barrier layers included in the active layer 206 can each be made of a nitride semiconductor such as InₓGa₁₋ₓN (where 0≦x<1), AlₓGa₁₋ₓN (where 0≦x<1), InGaAlN, GaN₁₋ₓAsₓ (where 0<x<1), GaN₁₋ₓPₓ (where 0<x<1), or a compound of any combination of the above substances. The active layer of the GaN-based semiconductor laser 20 preferably has a multiple quantum well (MQW) structure including two to four wells. This reduces an oscillation threshold. The active layer can, however, alternatively have a single quantum well (SQW) structure. In this case, the barrier layers individually sandwiched between the well layers are omitted from the example configuration described above.

### Embodiment 2

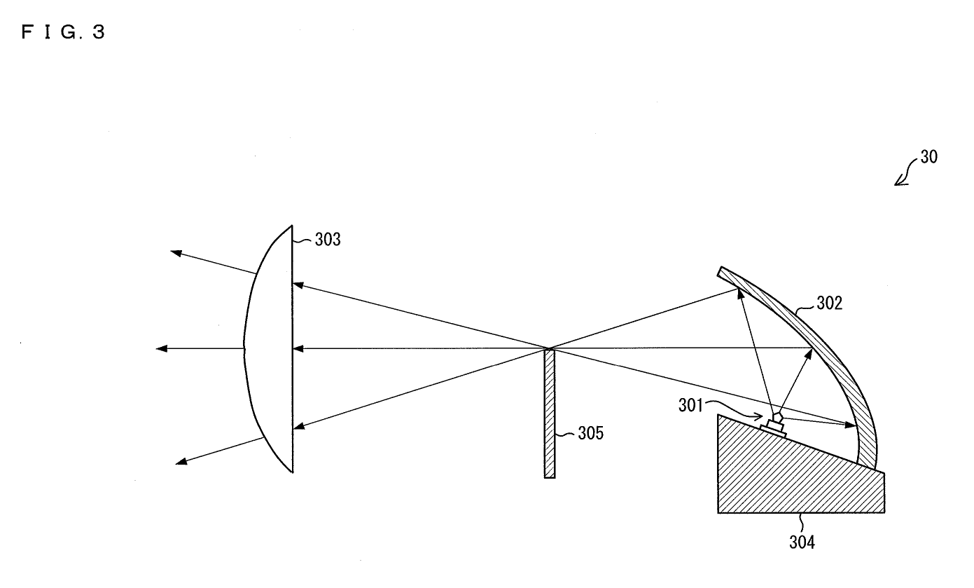

A second embodiment of the present invention is described below with reference to FIG. 3. The present embodiment is of a vehicle headlight, which serves as a specific example of an illumination device including the light-emitting device of Embodiment 1 above. FIG. 3 is a view schematically illustrating a configuration of a vehicle headlight 30 of the present embodiment.

The vehicle headlight 30 includes: a light-emitting device 301 identical to the light-emitting device of Embodiment 1; a reflecting mirror 302 for reflecting white light emitted from the light-emitting device 301; a projection lens 303; a support 304 for fixing the light-emitting device 301; and a light blocking plate 305 for forming a cut-off line for a passing beam.

The reflecting mirror 302 reflects light emitted from the light-emitting section 106 of the light-emitting device 301, and thus causes the light to travel in a forward direction in which the vehicle headlight 30 faces. The reflecting mirror 302, for example, has a curved surface (in a shape of a cup), and is provided with a metal thin film formed on a surface thereof.

The light-emitting section 106 of the light-emitting device 301 includes, as the phosphors 106b, Caα-SiAlON:Ce phosphors and CASN:Eu phosphors as in Embodiment 1. The light-emitting section 106 including a combination of the two kinds of phosphors is excellent in color rendering property as described in Embodiment 1. The light-emitting section 106 can thus allow a driver to see road signs and objects on roads better during the night.

Since the vehicle headlight 30 achieves both a high luminance and a high luminous flux, it is advantageously possible to reduce a size of the optical system included in the headlight, that is, the reflecting mirror 302 and the projection lens 303. The size refers to an effective area of the optical system (that is, the size of the optical system as viewed in a direction facing the front thereof). Specifically, the projection lens 303 (in a circular shape) of the vehicle headlight 30 as viewed in a direction facing the front thereof has a diameter of 20 mm, and emits light having a luminous intensity of 20000 cd, which is sufficient for a low beam headlight.

The light-emitting device 301 of the vehicle headlight 30 emits light having a luminance of 100 cd/mm² and a luminous flux of 1800 lm. As such, while the light has a loss of 35% due to the reflecting mirror 302 and the projection lens 303, the above optical system, although extremely small in size, provides a bright vehicle headlight as described above.

The vehicle headlight 30 of the present embodiment can naturally be used as a high beam headlight as well. In this case, in view of the fact that a luminous intensity of 100,000 cd is normally a necessary and sufficient condition for a high beam, the projection lens needs to have a diameter of 44 mm so that the optical system has an effective area necessary to achieve the luminous intensity of 100,000 cd.

As described above, the vehicle headlight 30 can characteristically not only be further downsized, but also have a low power consumption and a high color rendering property, as compared to conventional vehicle headlights.

An HID lamp equivalent in luminance and luminous flux to the vehicle headlight 30 will disadvantageously require, after being switched on, a certain amount of time to achieve its maximum luminous intensity. The vehicle headlight of the present embodiment, in contrast, characteristically not only achieves its maximum luminous intensity immediately after being switched on, but also can be instantaneously switched off and switched on again. This advantageously allows a driver to see much better immediately after switching on the headlight (i) during the night and (ii) after entering a tunnel, for example.

### Embodiment 3

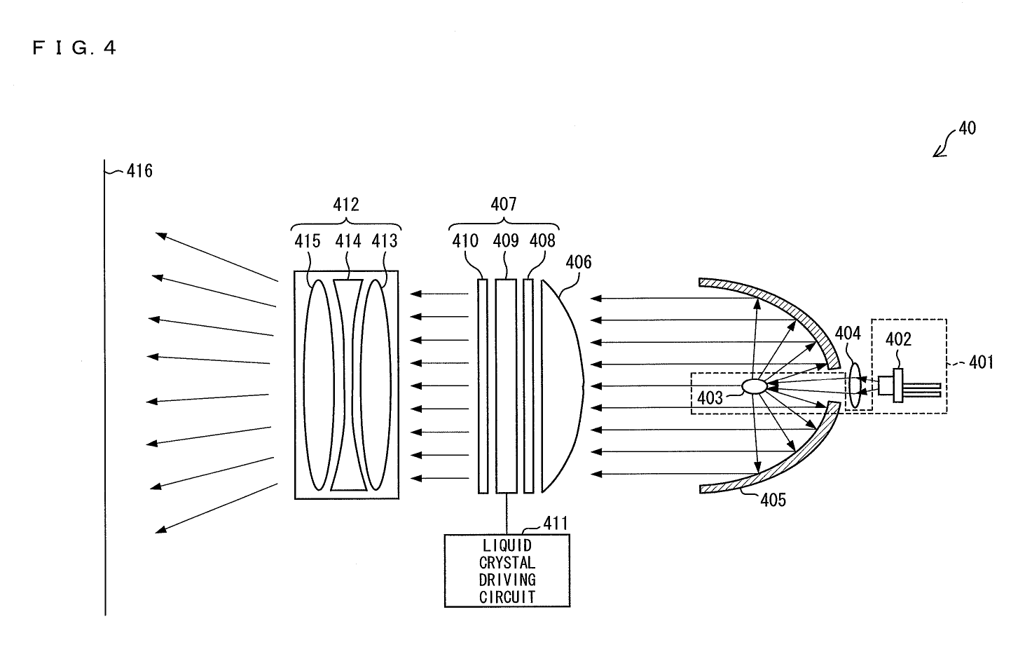

A third embodiment of the present invention is described below with reference to FIG. 4. The present embodiment is of a projector, which serves as a specific example of an illumination device including the light-emitting device of Embodiment 1 above. FIG. 4 is a view schematically illustrating a configuration of a projector 40 of the present embodiment.

The projector 40 includes: a light-emitting device 401; a condensing lens 404; a reflecting mirror 405; a condensing lens 406; a display panel 407 including (i) a polarizing plate 408, (ii) a liquid crystal panel 409, and (iii) a polarizing plate 410; a liquid crystal driving circuit 411 for driving the liquid crystal panel 409; and a projecting lens 412 including (i) a convex lens 413, (ii) a concave lens 414, and (iii) a convex lens 415.

The light-emitting device 401 of the present embodiment differs from the light-emitting device 10 of Embodiment 1 in that unlike in Embodiment 1, (i) the light-emitting device 401 includes a laser light source contained in a housing 402, and (ii) the condensing lens 404 is provided between the housing 402 and the light-emitting section 403 on an optical path for laser beams.

The light-emitting section 403 is held at a focal position of the reflecting mirror 405. The condensing lens 404 has a focal length which allows the light-emitting section 403 to emit a laser beam that has a power density of 1 W/mm² on its irradiating surface.

The light-emitting section 403 includes, dispersed therein, (i) JEM phosphors that emit blue fluorescence, (ii) β-SiAlON:Eu phosphors that emit green fluorescence having a sharp waveform peak (that is, having a narrow half width), and (iii) CASN:Eu phosphors that emit red fluorescence.

The β-SiAlON:Eu phosphors (green phosphors) used in the present embodiment have a half width of 45 nm at its light emission peak. This contributes to a wider color reproduction range of the projector.

The light-emitting device 401 having the above arrangement emitted, with a power consumption of 35W, light having a luminance of 80 cd/mm² and a total luminous flux of 1600 lm. The light-emitting device 401 also achieved 95% in NTSC ratio, which is a common indicator of color reproducibility of an image display device.

The projector 40 includes an extremely small light source section and has a low power consumption. The projector 40 can thus be drastically smaller in size and lower in power consumption than a conventional projector including a mercury lamp or a xenon lamp as a light source. Further, the lower power consumption allows a large reduction in heat generated in the projector 40, and consequently eliminates the need for a large heat dissipation fan which tends to cause unpleasant noise. As a result, marketability of the projector is advantageously increased.

The projector 40, which includes as a light source a light-emitting device having a high luminance and a high luminous flux, is sufficiently useful even in a bright area despite its extremely small size.

The light-emitting device 401 of the present embodiment can include a GaN-based semiconductor laser having an oscillation wavelength which falls within a range from 440 nm to 470 nm. In this case, the light-emitting section 403 (i) includes no JEM phosphors and (ii) uses, as projection light, blue light from the GaN-based semiconductor laser which blue light is incoherent light generated by dispersion of a laser beam by green and red phosphors.

This arrangement not only allows use of β-SiAlON:Eu phosphors having a narrow half width at its light emission peak, but also makes it possible to cause light to have a single wavelength (blue light). As such, it is possible to further widen the color reproduction range of the projector.

The description of the present embodiment discloses an example configuration of a projector including a liquid crystal panel and polarizing plates. The present invention is, however, naturally not limited to this. The present invention can thus also be suitably carried out in a form of, for example, a light source for a DLP (digital light processing) projection projector including a DMD (digital micro-mirror device).

### Embodiment 4

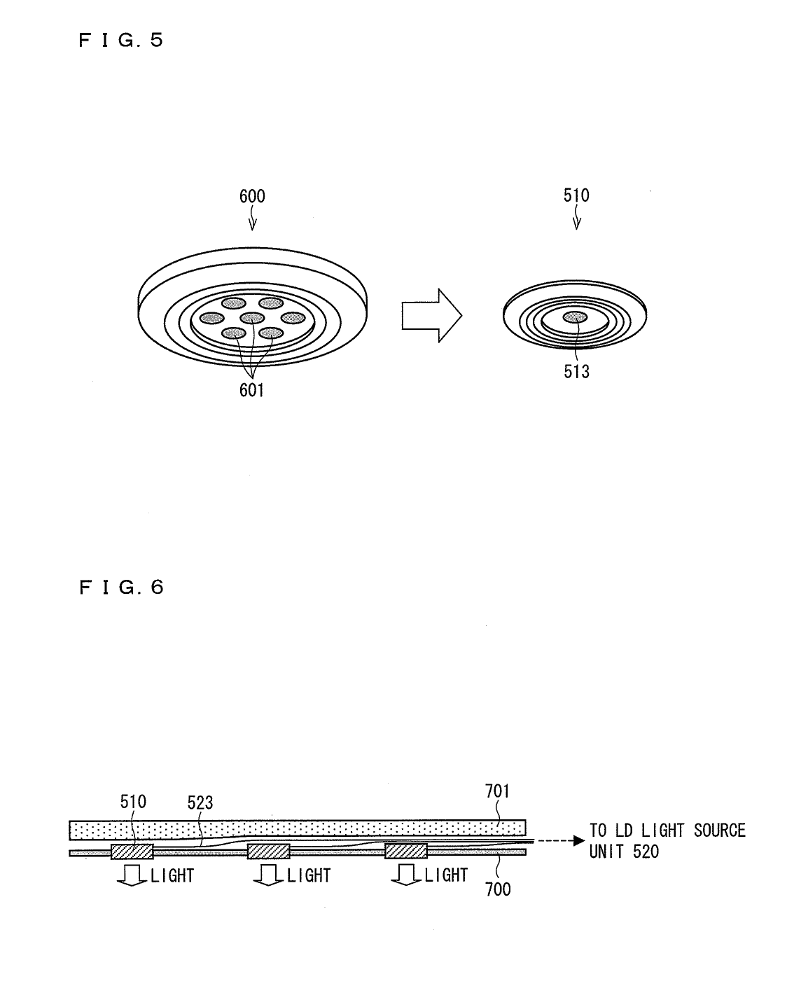

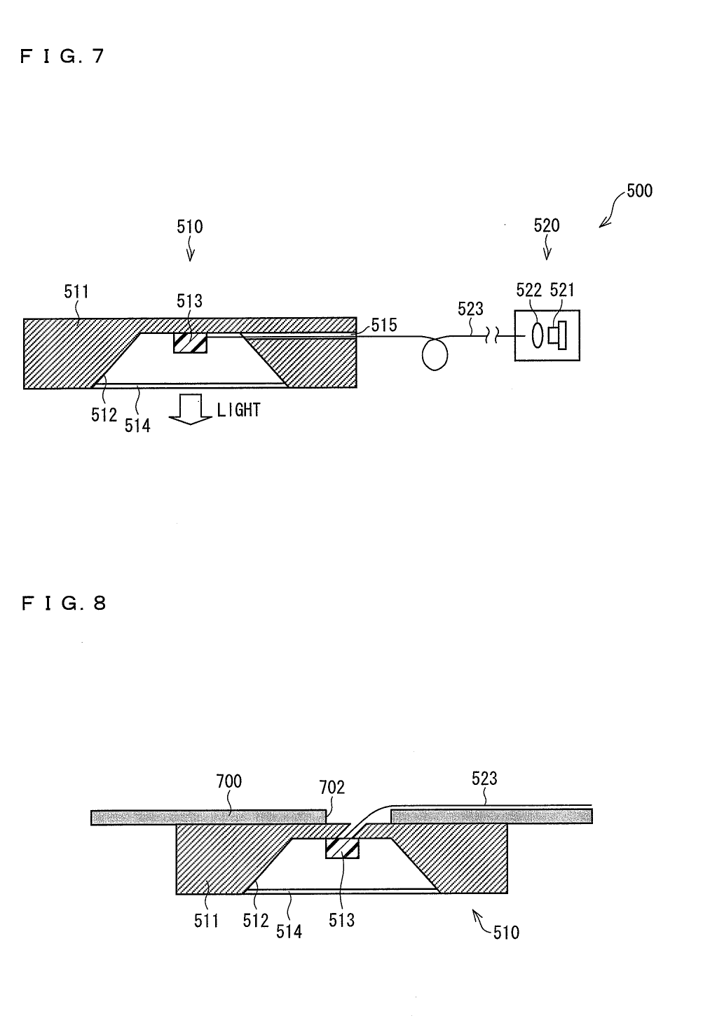

A fourth embodiment of the present invention is described below with reference to FIGS. 5 through 10. The present embodiment is of a laser downlight, which serves as a specific example of an illumination device including the light-emitting device of Embodiment 1 above. FIG. 7 is a cross-sectional view illustrating a laser downlight 500 of the present embodiment.

As illustrated in FIG. 7, the laser downlight 500 is an illumination device to be installed on an inside surface of a roof of a structure such as a house or a vehicle. The laser downlight 500 causes a laser light source 521 to emit a laser beam to a light-emitting section 513 so that the light-emitting section 513 emits fluorescence in response. The laser downlight 500 uses the fluorescence as illumination light.

The laser downlight 500 can alternatively be installed on a sidewall or floor of the structure. The installation of the laser downlight 500 is not particularly limited in terms of location.

FIG. 5 is a view schematically illustrating an appearance of each of a light-emitting unit 510 and a conventional LED downlight 600. FIG. 6 is a cross-sectional view illustrating a ceiling for which the laser downlight 500 is installed. As illustrated in FIGS. 5 through 7, the laser downlight 500 includes: light-emitting units 510 each for emitting illumination light; and an LD light source unit 520 for supplying a laser beam to each light-emitting unit 510 via an optical fiber 523. The light-emitting units 510 are embedded in the ceiling through a ceiling board 700.

The LD light source unit 520 is installed not on the ceiling, but at such a location as to allow a user to reach it easily (for example, on a sidewall of a house). The LD light source unit 520 can be installed at any desired location as above because the LD light source unit 520 is connected to the light-emitting units 510 via the respective optical fibers 523. The optical fibers 523 are provided in a gap between the ceiling board 700 and a heat insulator 701. The optical fibers 523 each have (i) a first end section, that is, an entrance end section, connected to the LD light source unit 520 and (ii) a second end section, that is, an emission end section, connected to a corresponding light-emitting unit 510.

### (Configuration of Light-Emitting Unit 510)

As illustrated in FIG. 7, each of the light-emitting units 510 includes: a housing 511; a light-emitting section 513; and a light-transmitting plate 514, and is connected to an optical fiber 523.

The housing 511 has a recess 512 having a bottom surface, on which the light-emitting section 513 is provided. The recess 512 is provided with a metal thin film formed on a surface thereof so as to function as a reflecting mirror.

The housing 511 has a passage 515 for allowing the optical fiber 523 to pass through. The optical fiber 523 extends from the LD light source unit 520 to the light-emitting section 513 through the passage 515. The emission end section of the optical fiber 523 emits a laser beam which has, on an irradiation surface of the light-emitting section 513, a power density having a value identical to the value specified in Embodiment 1.

The light-transmitting plate 514 is a transparent or semitransparent plate provided at such a location as to block an opening of the recess 512. The light-transmitting plate 514 is identical in function to the cap glass section 105 described in Embodiment 1. The light-emitting section 513 emits fluorescence through the light-transmitting plate 514 as illumination light. The light-transmitting plate 514 can be detachable from the housing 511 or omitted.

The light-transmitting plate 514, which is as described above a transparent or semitransparent plate provided at such a location as to block an opening of the recess 512, is provided at a location along a direction in which light emitted from the laser light source 521 travels to the outside. The light-transmitting plate 514 is preferably made of a material which blocks a laser beam from the laser light source 521 and which transmits white light (incoherent light) generated by conversion of a laser beam by the light-emitting section 513.

Coherent laser light transmitting the light-emitting section 513 either excites the phosphors in the light-emitting section 513 so as to be converted into fluorescence or is scattered by the phosphors so that a size of its light-emitting point is sufficiently increased. The size of the light-emitting point may, however, not be increased for some reason. Even in such a case, the light-transmitting plate 514 blocks laser light so as to prevent leaking out of laser light whose light-emitting point is small in size and which is thus hazardous to the human eye.

The light-emitting unit 510 illustrated in FIG. 5 has a circular outer edge. The light-emitting unit 510 (more specifically, the housing 511) is, however, not particularly limited in terms of shape.

Unlike a headlamp, a downlight does not require an ideal point light source, and can simply include a single light-emitting point. As such, the light-emitting section 513 has fewer restrictions in terms of shape, size, and location than does a headlamp.

### (Configuration of LD Light Source Unit 520)

The LD light source unit 520 includes: a laser light source 521; and an aspheric lens 522, and is connected to an optical fiber 523.

The optical fiber 523 has a first end section, that is, an entrance end section, connected to the LD light source unit 520. The laser light source 521 emits a laser beam which travels through the aspheric lens 522 to enter the entrance end section of the optical fiber 523.

The LD light source unit 520 illustrated in FIG. 7 contains a single pair of (i) the laser light source 521 and (ii) the aspheric lens 522. In a case where the laser downlight 500 includes a plurality of light-emitting units 510, respective optical fibers 523 extending from the plurality of light-emitting units 510 can be tied into a bundle to be connected to a single LD light source unit 520. In this case, the single LD light source unit 520 contains a plurality of pairs of (i) the laser light source 521 and (ii) the aspheric lens 522 (or a pair of (i) a plurality of laser light sources 521 and (ii) a single rod-shaped lens) so as to function as a central power supply box.

### (Another Example Manner of Installing Laser Downlight 500)

FIG. 8 is a cross-sectional view illustrating an example variation of how the laser downlight 500 is installed. As illustrated in FIG. 8, the laser downlight 500 can alternatively be installed in such a manner as to make efficient use of small thickness and light weight of the light-emitting unit 510, specifically, so that a body of the laser downlight 500 (that is, the light-emitting unit 510) is attached to a surface of a ceiling board 700 having a small hole 702 through which the optical fiber 523 extends. This arrangement advantageously reduces the number of restrictions on the installation of the laser downlight 500, and also greatly reduces a construction cost for the installation.

(Comparison between Laser Downlight 500 and Conventional LED Downlight 600)

As illustrated in FIG. 5, the conventional LED downlight 600 includes a plurality of light-transmitting plates 601, from each of which illumination light is emitted. In other words, the LED downlight 600 includes a plurality of light-emitting points. This is because the LED downlight 600 requires such a plurality of light-emitting points in order to emit light having a luminous flux that is sufficient for illumination light. Note that the individual light-emitting points each emit light having a relatively small luminous flux.

The laser downlight 500, in contrast, is an illumination device having a high luminous flux, and thus simply requires only one light-emitting point. As such, the laser downlight 500 emits illumination light which causes beautiful shading. Further, in a case where the light-emitting section 513 includes, as its phosphors, phosphors having a high color rendering property, it is possible to improve a color rendering property of the illumination light. The above phosphors having a high color rendering property are, for example, a combination of a plurality of kinds of oxynitride phosphors or nitride phosphors.

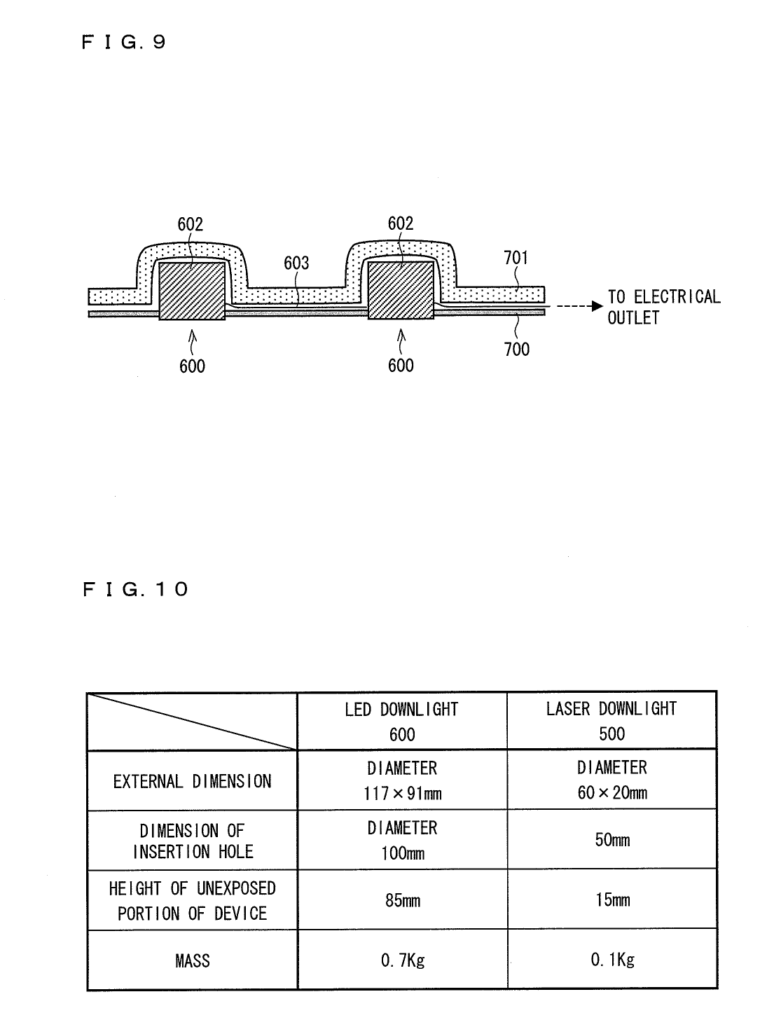

FIG. 9 is a cross-sectional view illustrating a ceiling for which LED downlights 600 are installed. As illustrated in FIG. 9, the LED downlights 600 each include a housing 602 embedded in a ceiling board 700. The housing 602 contains an LED chip, a power supply, and a cooling unit. Further, the housing 602 is relatively large. The ceiling thus includes a heat insulator 701 having recesses at locations at which the housings 602 are provided, the recesses each being in such a shape as to match a housing 602. The LED downlights 600 each further include a power supply line 603 which extends from a corresponding housing 602 to an electrical outlet (not shown) so as to be connected thereto.

This conventional arrangement, however, poses the following problems: First, use of the LED downlights 600 increases a temperature in the ceiling and thus reduces efficiency in air conditioning for a room. This temperature increase is due to light sources (LED chips) and power supplies, each of which is a heat source, provided between the ceiling board 700 and the heat insulator 701.

Second, each of the LED downlights 600 requires a power supply and a cooling unit for its light source. This increases an overall cost.

Third, since the housings 602 are each relatively large, it is often difficult to install the LED downlights 600 in a gap between the ceiling board 700 and the heat insulator 701.

In contrast, the laser downlight 500 has the following advantages: First, the light-emitting unit 510 includes no large heat source, and thus does not decrease efficiency in air conditioning for a room. As such, it is possible to prevent an increase in cost of air conditioning for a room.

Second, the laser downlight 500 does not require a power supply and a cooling unit for each light-emitting unit 510, and can thus be made small in size and thickness. As such, it is possible to reduce the number of restrictions on a space for installing the laser downlight 500, and thus to easily install the laser downlight 500 in an existing house.

Third, since the laser downlight 500 is small in size and thickness, it is possible to install the light-emitting unit 510 on a surface of the ceiling board 700 as described above. As such, as compared to the case of the LED downlights 600, it is possible to reduce the number of restrictions on installation, and greatly reduce a construction cost.

FIG. 10 is a table which compares specs of the laser downlight 500 with those of the LED downlight 600. As shown in FIG. 10, the laser downlight 500 is, according to an example thereof, 94% smaller in volume and 86% smaller in mass than the LED downlight 600.

Since the LD light source unit 520 can be installed at such a location as to allow a user to reach it easily, a broken laser light source 521 can be easily replaced. Further, in the case where the respective optical fibers 523 extending from a plurality of light-emitting units 510 are tied into a bundle to be connected to a single LD light source unit 520, it is possible to control a plurality of laser light sources 521 all together. As such, even a plurality of laser light sources 521 can be replaced easily.

An LED downlight 600 which includes phosphors having a high color rendering property emits light having a luminous flux of approximately 500 lm with a power consumption of 10 W. The laser downlight 500, in contrast, merely requires an optical power of only 3.3 W in order to emit light having the same brightness. This optical power is equivalent to a power consumption of 10W in a case where the laser downlight 500 has an LD efficiency of 35%. Since the power consumption of the LED downlight 600 is also 10W, there is no significant difference in power consumption between the LED downlight 600 and the laser downlight 500. This indicates that the laser downlight 500 achieves the above advantages with the same power consumption as the LED downlight 600.

### SUMMARY OF EMBODIMENTS

As described above, the light-emitting device of each of the above embodiments includes: a laser light source for emitting a laser beam; and a light-emitting section having an irradiation surface which the laser beam irradiates, the light-emitting section emitting light in response to the irradiation of the irradiation surface by the laser beam, the laser beam having, on the irradiation surface, a power density which falls within a range from 0.1 W/mm² to 100 W/mm².

In the above light-emitting device, the laser beam has, on the irradiation surface of the light-emitting section, a power density which falls within a range from 0.1 W/mm² to 100 W/mm². This arrangement (i) allows the light-emitting section to emit high-power light and yet (ii) prevents the light-emitting section from being degraded. As such, it is possible to provide a light-emitting device which can emit light having a high luminance and a high luminous flux.

The term “power density” as used herein refers to a quotient obtained by dividing (i) an output of the laser beam, emitted from the laser light source to irradiate the light-emitting section, by (ii) an area of the irradiation surface of the light-emitting section.

In a case where the light-emitting section has a luminous efficiency of only approximately 50%, the power density preferably falls within a range from 1.0 W/mm² to 100 W/mm².

For example, in the case where the light-emitting section has a luminous efficiency of approximately 50%, the light-emitting section has a light-emitting output of only 0.5 W even if the laser light source has an output of, for example, 1 W. If the light-emitting section has a light-emitting output of 0.5 W, the light-emitting section cannot emit light having a total luminous flux of 100 lm or greater. A total luminous flux of 100 lm is necessary for a light source to be suitably used in a headlamp or a projector. As such, in the above case, the laser beam has, on the irradiation surface of the light-emitting section, a power density which falls within the range from 1.0 W/mm² to 100 W/mm².

It is preferable that the laser light source includes an emission end surface for emitting the laser beam; and the emission end surface is in contact with dry air.

With this arrangement, the emission end surface of the laser light source is in contact with dry air. As such, the laser light source is stably supplied with a driving voltage even in a case where it emits a high-power laser beam. It follows that the laser light source can emit a high-power laser beam.

The light-emitting device preferably further includes a housing containing the laser light source and serving to cause the laser beam to irradiate the irradiation surface, wherein: the housing is sealed so as to contain dry air.

With this arrangement, the laser light source is contained in the housing that is sealed so as to contain dry air. As such, the laser light source can stably emit a high-power laser beam for an extended period of time.

The light-emitting section preferably includes a phosphor supporting member and a phosphor dispersed in the phosphor supporting member and emitting light on irradiation of the laser beam. Further, the phosphor preferably includes at least one of an oxynitride phosphor, a nitride phosphor, and a semiconductor nanoparticle phosphor, the at least one being selected from the group consisting of CASN:Eu phosphor, SCASN:Eu phosphor, Caα-SiAlON:Ce phosphor, β-SiAlON:Eu phosphor, and JEM phosphor.

This arrangement allows the light-emitting section to maintain a high luminous efficiency and high reliability in emitting a laser beam having a high power density. As such, it is possible to provide a light-emitting device which emits light having a high luminance and a high luminous flux.

The term “CASN:Eu” represents CaAlSiN:Eu, “SCASN:Eu” represents SrCaAlSiN:Eu, and “JEM” represents LaSiAlON:Ce. The symbol “Ca” represents calcium, “Si” represents silicon, “Al” represents aluminum, “O” represents oxygen, “N” represents nitrogen, “Ce” represents cerium, and “Eu” represents europium. Further, “α-” and “β-” in the terms “α-SiAlON” and “β-SiAlON” indicate a difference in crystal structure, and respectively represent a low-temperature stable α-phase and a high-temperature stable β-phase.

It is preferable that the phosphor supporting member is an organic polymer member; and the power density falls within a range from 0.1 W/mm² to 10 W/mm².

With this arrangement, the phosphor supporting member is an organic polymer member. As such, it is possible to decrease an absorption loss of a laser beam in the phosphor supporting member. As a result, it is possible to improve a luminous efficiency of the light-emitting section.

The laser beam preferably has, on the irradiation surface of the light-emitting section, a power density which has an upper limit of 10 W/mm² in view of heat resistance of the organic polymer member, that is, the phosphor supporting member of the light-emitting section.

In the case where the phosphor supporting member is an organic polymer member, it is possible to achieve the following advantage.

Many organic polymers are liquid at room temperature. An organic polymer is hardened merely on heating at a relatively low temperature (for example, 100° C. to 250° C.). The phosphor supporting member can thus be hardened with use of a mold which does not necessarily have high heat resistance. Such a mold can be made of any of a wider variety of materials, and can thus have any shape. As such, it is possible to produce light-emitting sections greatly varying from each other in shape.

For hardening, a silicone resin of a lower temperature firing type, for example, requires a temperature of approximately 100° C., a normal silicone resin requires a temperature approximately from 150° C. to 180° C., and an organic-inorganic hybrid material requires a temperature approximately from 150° C. to 250° C.

In a case where the phosphor supporting member is made of glass, it is necessary to carry out a high temperature process of heating glass at a high temperature of approximately at least 400° C. to 500° C. so as to make the glass fluid. The necessity to carry out a high temperature process greatly decreases working efficiency in producing a light-emitting section. In contrast, in the case where the phosphor supporting member is an organic polymer member, such a high temperature process is unnecessary. As a result, it is possible to improve working efficiency in process of producing a light-emitting section, and consequently to reduce a cost of producing the light-emitting section.

The organic polymer member preferably has a chemical structure which includes (i) a siloxane-bonded main chain and (ii) a side chain of an organic group.

With this arrangement, the light-emitting section is more tolerant of emitting a laser beam having a high power density. As such, it is possible to provide a light-emitting device which highly reliably emits light having a high luminance and a high luminous flux.

The organic polymer member is preferably a silicone resin including a side chain of a methyl group (CH₃—).

With this arrangement, the organic polymer member is a silicone resin which does not unusually absorb light within a visible light wavelength range. As such, it is possible to provide a more reliably light-emitting section.

The dry air preferably has a dew point temperature of −30° C. or lower.

With this arrangement, the dry air has a dew point temperature of −30° C. or lower. As such, it is possible to improve reliability of the laser light source in operation. Specifically, it is possible to prevent a change in an operating voltage of the laser light source, and consequently to emit stable excitation light for an extended period of time.

It is preferable that the housing includes a transmitting section for transmitting the laser beam; and the transmitting section is made of an organic polymer member.

With this arrangement, it is possible to reduce a power loss of the laser beam which power loss is caused when the laser beam passes through the transmitting section. As such, it is possible to provide a light-emitting device having a high luminous efficiency and emitting light having a high luminance and a high luminous flux.

The laser light source preferably has an oscillation wavelength which falls within a range from 400 nm to 420 nm.

With this arrangement, the laser beam has an oscillation wavelength which falls within the range from 400 nm to 420 nm. As such, the laser beam is not converted by the light-emitting section into light having a different wavelength. Even in a case where the laser beam is emitted outside the light-emitting section, the laser beam causes no skin disorder expressed by light having a wavelength of shorter than 400 nm. Further, the laser beam has a wavelength of not longer than 420 nm, and is thus low in luminosity. As such, the laser beam does not cause a large decrease in color rendering property of light emitted from the light-emitting section. In addition, in a case where the light-emitting section includes, as the above oxynitride phosphors or nitride phosphors, a kind of phosphors selected from the above group (CASN:Eu phosphors, SCASN:Eu phosphors, Caα-SiAlON: Ce phosphors, β-SiAlON:Eu phosphors, and JEM phosphors), since any phosphors from the group have high absorptance for the above laser beam, it is possible to provide a light-emitting device having a high efficiency and emitting light having a high luminance and a high luminous flux.

The laser light source preferably has an oscillation wavelength which falls within a range from 440 nm to 470 nm.

With this arrangement, the light-emitting section emits light in response to a laser beam having a wavelength which falls within the range of blue light, that is, the range from 440 nm to 470 nm. As such, it is possible to reduce a Stokes loss (that is, an energy loss arising from a difference between an excitation wavelength and a fluorescence wavelength), and thus cause the light-emitting section to emit light with higher efficiency. As a result, it is possible to provide a light-emitting device having a high luminous efficiency and emitting light having a high luminance and a high luminous flux.

An illumination device of each of the above embodiments includes one of the above light-emitting devices as a light source.

In a case where the illumination device is a vehicle headlight, the illumination device, which includes a light-emitting device that emits light having a high luminance and a high luminous intensity, has a reduced power consumption as compared to a conventional headlight including a halogen lamp or HID lamp. Further, it is also possible to downsize an optical system since the illumination device emits light having a high luminance and generates only a small amount of heat. As a result, it is possible to greatly improve flexibility in design as compared to conventional headlights.

In a case where the illumination device is a projector, it is possible to downsize the projector and allow the projector to have a low power consumption. This is because the projector includes as a light source a light-emitting device which (i) is compact, (ii) has a low power consumption, and (iii) has a high luminance and a high luminous flux, as compared to a conventional projector including a mercury lamp or a xenon lamp as a light source.

A vehicle headlight of an embodiment above includes one of the above light-emitting devices as a light source.

The vehicle headlight, which includes a light-emitting device that emits light having a high luminance and a high luminous intensity, has a reduced power consumption as compared to a conventional headlight including a halogen lamp or HID lamp. Further, it is also possible to downsize an optical system since the illumination device emits light having a high luminance and generates only a small amount of heat. As a result, it is possible to greatly improve flexibility in design as compared to conventional headlights.

The present invention is not limited to the description of the embodiments above, but may be altered in various ways by a skilled person within the scope of the claims. Any embodiment based on a proper combination of technical means disclosed in different embodiments is also encompassed in the technical scope of the present invention.

The illumination device of the present invention can alternatively be used as, for example, a headlamp for a vehicle or moving object other than an automobile (for example, a person, a vessel, an airplane, a submersible vessel, or a rocket). The illumination device of the present invention can further alternatively be used as another type of an illumination device such as a searchlight, a projector, or a household illumination instrument.

The present invention can alternatively be described as follows: A solid-state point light source of the present invention includes: an organic polymer member including an oxynitride phosphor or nitride phosphor dispersed therein; and a GaN-based semiconductor laser having a laser beam emission end surface in contact with dry air, the GaN-based semiconductor laser emitting a laser beam to the organic polymer member to excite the organic polymer member so that the organic polymer member emits light, the laser beam having a power density which falls within a range from 0.1 W/mm² to 10 W/mm².

It is preferable that the GaN-based semiconductor laser is contained in a stem sealed so as to contain the dry air; and the laser beam is emitted from a laser beam ejecting section of the stem to irradiate the organic polymer member.

The oxynitride phosphor or nitride phosphor preferably includes at least one kind of an oxynitride phosphor or nitride phosphor selected from the group consisting of CASN:Eu phosphor, SCASN:Eu phosphor, Caα-SiAlON:Ce phosphor, β-SiAlON:Eu phosphor, and JEM phosphor.

The organic polymer member preferably has a chemical structure which includes a siloxane-bonded main chain and a side chain of an organic group.

The organic polymer member is preferably a silicone resin including a side chain of a methyl group (CH₃—).

The dry air preferably has a dew point temperature of −30° C. or lower.

It is preferable that the GaN-based semiconductor laser is contained in the stem sealed so as to contain the dry air; and the laser beam ejecting section of the stem is hermetically coated with the organic polymer member.

The GaN-based semiconductor laser preferably has an oscillation wavelength which falls within a range from 400 nm to 410 nm.

The GaN-based semiconductor laser preferably has an oscillation wavelength which falls within a range from 440 nm to 470 nm.

A vehicle headlight of the present invention includes the solid-state point light source.

A projector of the present invention includes the solid-state point light source.

### INDUSTRIAL APPLICABILITY

The present invention provides an illumination device including a light-emitting device which functions as a light source that can emit light having a high luminance and a high luminous flux. In particular, the present invention is suitably applicable to a headlamp of, for example, a vehicle.

### Reference Signs List

10, 301, 401 light-emitting device
20 GaN-based semiconductor laser
30 vehicle headlight
40 projector
101, 521 laser light source
101a front end surface (emission end surface)
101b rear end surface
102 stem block
103 stem
104 cap
105 cap glass section
106, 403, 513 light-emitting section
106a phosphor supporting material (phosphor supporting member, organic polymer member)
106b phosphor
107a, 107b electrode lead
108 insulating resin
109 Au wire
110 laser driver circuit
201 n-type GaN substrate
202 n-type GaN layer
203 n-type Al_{0.05}Ga_{0.95}N lower clad layer
204 n-type GaN guide layer
205 GaN lower adjacent layer
206 active layer
207 GaN upper adjacent layer
208 p-type Al_{0.2}Ga_{0.8}N layer
209 p-type Al_{0.1}Ga_{0.9}N upper clad layer
210 p-type GaN contact layer
211 n-side electrode
212 insulating layer
213 p-side electrode
214 first layer
215 second layer
216 third layer
302, 405 reflecting mirror
303 projection lens
304 support
305 light blocking plate
402, 511, 602 housing
404, 406 condensing lens
407 display panel
408, 410 polarizing plate
409 liquid crystal panel
411 liquid crystal driving circuit
412 projecting lens
413, 415 convex lens
414 concave lens
416 screen
500 laser downlight
510 light-emitting unit
512 recess
514, 601 light-transmitting plate
515 passage
520 LD light source unit
522 aspheric lens
523 optical fiber
600 LED downlight
603 power supply line
700 ceiling board
701 heat insulator

1. A light-emitting device, comprising:
a laser light source for emitting a laser beam; and
a light-emitting section having an irradiation surface which the laser beam irradiates, the light-emitting section emitting light in response to the irradiation of the irradiation surface by the laser beam,
the laser beam having, on the irradiation surface, a power density which falls within a range from 0.1 W/mm² to 100 W/mm².

2. The light-emitting device according to claim 1,
wherein:
the laser light source includes an emission end surface for emitting the laser beam; and
the emission end surface is in contact with dry air.

3. The light-emitting device according to claim 1, further comprising:
a housing containing the laser light source and serving to cause the laser beam to irradiate the irradiation surface,
wherein:
the housing is sealed so as to contain dry air.

4. The light-emitting device according to claim 1,
wherein:
the light-emitting section includes a phosphor supporting member and a phosphor dispersed in the phosphor supporting member and emitting light on irradiation of the laser beam.

5. The light-emitting device according to claim 4,
wherein:
the phosphor includes at least one of an oxynitride phosphor, a nitride phosphor, and a semiconductor nanoparticle phosphor, the at least one being selected from the group consisting of CASN:Eu phosphor, SCASN:Eu phosphor, Caα-SiAlON:Ce phosphor, β-SiAlON:Eu phosphor, and JEM phosphor.

6. The light-emitting device according to claim 4,
wherein:
the phosphor supporting member is an organic polymer member; and
the power density falls within a range from 0.1 W/mm² to 10 W/mm².

7. The light-emitting device according to claim 6,
wherein:
the organic polymer member has a chemical structure which includes (i) a siloxane-bonded main chain and (ii) a side chain of an organic group.

8. The light-emitting device according to claim 7,
wherein:
the organic polymer member is a silicone resin including a side chain of a methyl group (CH₃—).

9. The light-emitting device according to claim 2,
wherein:
the dry air has a dew point temperature of −30° C. or lower.

10. The light-emitting device according to claim 3,
wherein:
the housing includes a transmitting section for transmitting the laser beam; and
the transmitting section is made of an organic polymer member.

11. The light-emitting device according to claim 1,
wherein:
the laser light source has an oscillation wavelength which falls within a range from 400 nm to 420 nm.

12. The light-emitting device according to claim 1,
wherein:
the laser light source has an oscillation wavelength which falls within a range from 440 nm to 470 nm.

13. An illumination device, comprising:
as a light source, the light-emitting device recited in claim 1.

14. A vehicle headlight, comprising:
as a light source, the light-emitting device recited in claim 1.
